(19) United States
(12) Patent Application Publication
(10) Pub. No.: US 2026/0112535 A1
(43) Pub. Date: Apr. 23, 2026

(54) COIL COMPONENT

(71) Applicant: SAMSUNG ELECTRO-MECHANICS CO., LTD., Suwon-si (KR)

(72) Inventors: Boum Seock KIM, Suwon-si, Gyeonggi-do (KR); Jong Pil LEE, Suwon-si, Gyeonggi-do (KR); Jong Wook LEE, Suwon-si, Gyeonggi-do (KR); Hyun Kyu IM, Suwon-si, Gyeonggi-do (KR); Hyeong Joo JIN, Suwon-si, Gyeonggi-do (KR); Sang Jin KIM, Suwon-si, Gyeonggi-do (KR)

(73) Assignee: SAMSUNG ELECTRO-MECHANICS CO., LTD., Suwon-si (KR)

(21) Appl. No.: 19/251,396

(22) Filed: Jun. 26, 2025

(30) Foreign Application Priority Data
Oct. 21, 2024 (KR) 10-2024-0144031

(51) Int. Cl. H01F 27/29; H01F 27/30; H01F 27/32

(52) U.S. Cl. CPC H01F 27/292; H01F 27/306; H01F 27/327

(57) ABSTRACT

A coil component includes a body including a first surface and a second surface opposing each other in a first direction, and a third surface and a fourth surface opposing each other in a second direction and each having a recess formed therein, a coil disposed within the body and having both ends extending to the recesses, an external electrode disposed on the first surface of the body and extending to the recesses so as to be connected to both ends of the coil, a first insulating layer disposed on the first surface of the body and having a first opening formed therein, and a second insulating layer disposed on the first insulating layer and having a second opening formed therein, wherein at least a portion of the external electrode is disposed in the first opening and the second opening.

### CROSS-REFERENCE TO RELATED APPLICATION(S)

This application claims benefit of priority to Korean Patent Application No. 10-2024-0144031 filed on Oct. 21, 2024 in the Korean Intellectual Property Office, the disclosure of which is incorporated herein by reference in its entirety.

### TECHNICAL FIELD

The present disclosure relates to a coil component.

Inductors, coil components, are representative passive electronic components used in electronic devices along with resistors and capacitors.

As electronic devices have been implemented with high performance and have become smaller, electronic components used in electronic devices have increased in number and have become compact.

As coil components have become thinner and smaller, in the case of power inductors having a bottom electrode structure, plating spreading defects in which an electrode formed on a bottom surface of a component spreads to an upper surface of the component may occur. In addition, if an insulation thickness of an external surface of the component is uneven or thick, volume loss of a magnetic body may occur.

### SUMMARY

An aspect of the present disclosure is to improve an effective volume of a magnetic body by uniformizing an insulation thickness of a coil component.

Another aspect of the present disclosure is to control a plating spreading phenomenon when an external electrode of a coil component is plated.

According to an aspect of the present disclosure, a coil component includes: a body including a first surface and a second surface opposing each other in a first direction, a third surface and a fourth surface opposing each other in a second direction and each having a recess formed therein, and a fifth surface and a sixth surface opposing each other in a third direction; a coil disposed within the body and having both ends extending to the recesses; an external electrode disposed on the first surface of the body and extending to the recesses so as to be connected to both ends of the coil; a first insulating layer disposed on the first surface of the body and having a first opening formed therein; and a second insulating layer disposed on the first insulating layer and having a second opening formed therein, wherein at least a portion of the external electrode is disposed in the first opening and the second opening.

### BRIEF DESCRIPTION OF DRAWINGS

The and other aspects, features, and advantages of the present disclosure will be more clearly understood from the following detailed description, taken in conjunction with the accompanying drawings, in which:

FIG. 1 is a diagram schematically illustrating a coil component according to a first embodiment of the present disclosure;

FIG. 2 is a bottom view of a coil component according to the first embodiment of the present disclosure;

FIG. 3 is a diagram illustrating that a second insulating layer and a second metal layer are omitted in FIG. 2;

FIG. 4 is a diagram illustrating that a first insulating layer is omitted in FIG. 3;

FIG. 5 is a diagram illustrating that a first metal layer is omitted in FIG. 4;

FIG. 6 is a cross-sectional view taken along line I-I′ of FIG. 1;

FIG. 7 is a diagram illustrating that FIG. 1 is viewed in a first direction;

FIG. 8 is a diagram illustrating that a second insulating layer and a second metal layer are omitted in FIG. 7;

FIG. 9 is a cross-sectional view taken along line II-II′ of FIG. 7; and

FIGS. 10 and 11 are diagrams schematically illustrating modified examples of the coil component according to the first embodiment of the present disclosure, respectively, and are drawings corresponding to FIG. 6.

### DETAILED DESCRIPTION

The terms used herein to describe embodiments of the present disclosure is not intended to limit the scope of the present disclosure. The articles “a,” and “an” are singular, in that they have a single referent; however, the use of the singular form in the present document should not preclude the presence of more than one referent. In other words, elements of the present disclosure referred to in the singular may number one or more, unless the context clearly indicates otherwise. It will be further understood that the terms “comprise,” “comprising,” “include,” and/or “including,” when used herein, specify the presence of stated features, numbers, steps, operations, elements, and/or components but do not preclude the presence or addition of one or more other features, numbers, steps, operations, elements, components, and/or groups thereof.

The terms used in the present specification are merely used to describe particular embodiments and are not intended to limit the present disclosure. An expression used in the singular encompasses the expression of the plural, unless it has a clearly different meaning in the context. In the present specification, it is to be understood that the terms, such as “including” or “having,” etc., are intended to indicate the existence of the features, numbers, steps, actions, elements, parts, or combinations thereof disclosed in the specification, and are not intended to preclude the possibility that one or more other features, numbers, steps, actions, elements, parts, or combinations thereof may exist or may be added. Also, throughout the specification, “on” means to be located above or below a target portion and does not necessarily mean to be located on the upper side with respect to the direction of gravity.

In addition, coupling does not mean only the case of direct physical contact between each component in a contact relationship, but it should be used as a concept encompassing even a case in which another component is disposed between each component so that a component is in contact with the other component.

Since the size and thickness of each component illustrated in the drawings are arbitrarily illustrated for convenience of description, the present disclosure is not necessarily limited to the illustrated.

In the drawings, an X-direction may be defined as a first direction or thickness direction, a Y-direction may be defined as a second direction or length direction, and a Z-direction may be defined as a third direction or width direction.

Hereinafter, a coil component according to an embodiment in the present disclosure will be described in detail with reference to the accompanying drawings, and in the description with reference to the accompanying drawings, the same or corresponding components are assigned the same reference numerals and overlapping descriptions thereof will be omitted.

Various types of electronic components are used in electronic devices, and various types of coil components may be appropriately used between these electronic components for the purpose of removing noise.

That is, in electronic devices, coil components may be used as power inductors, high-frequency (HF) inductors, general beads, GHz beads, common mode filters, etc.

### First Embodiment

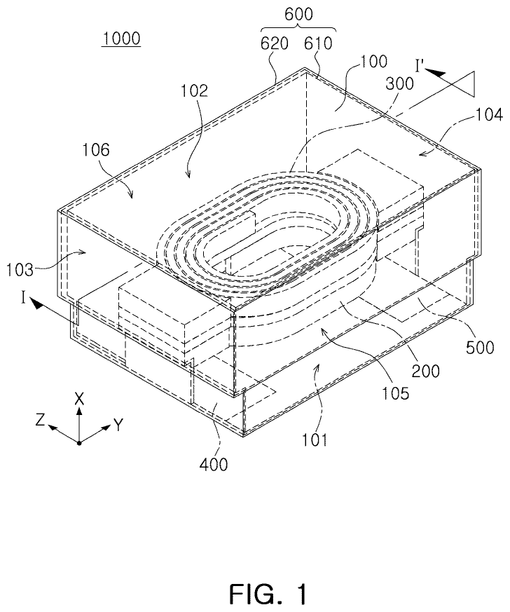

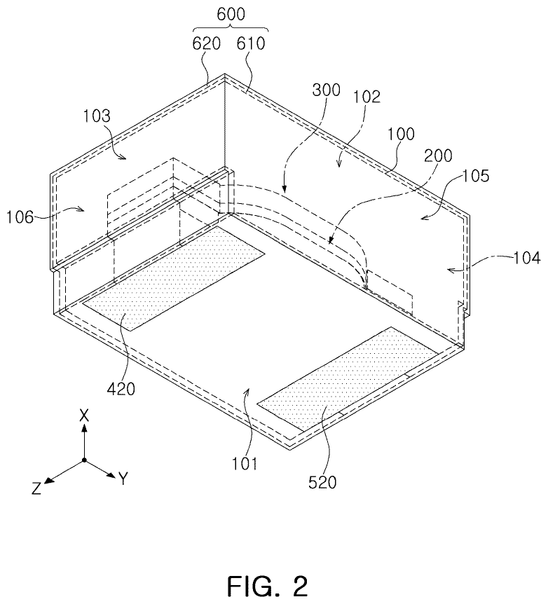

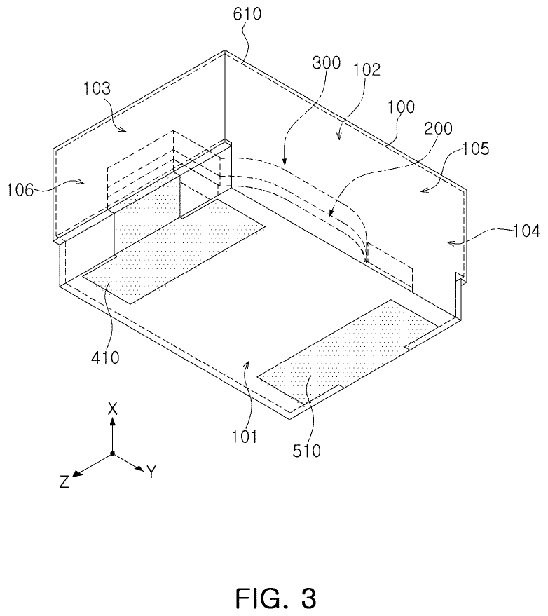

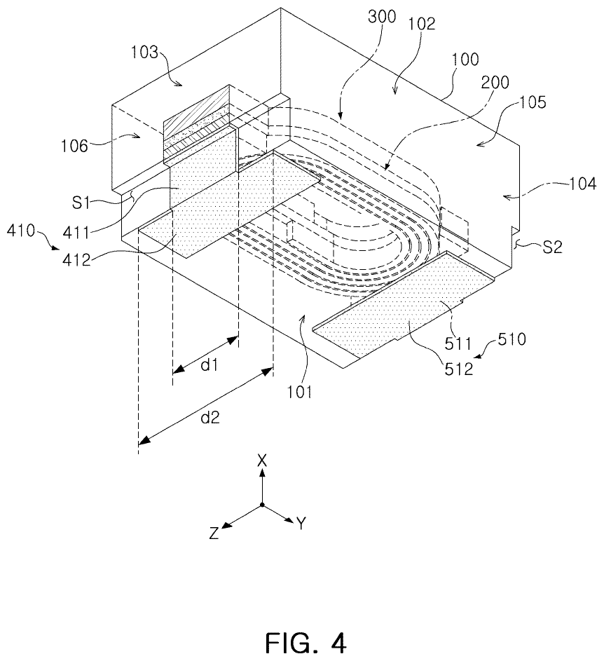

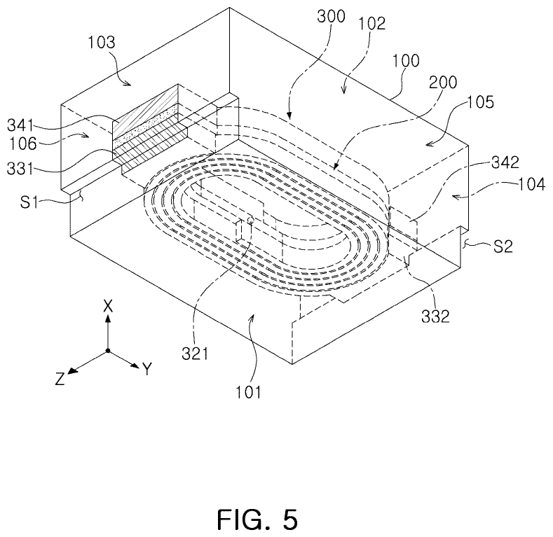

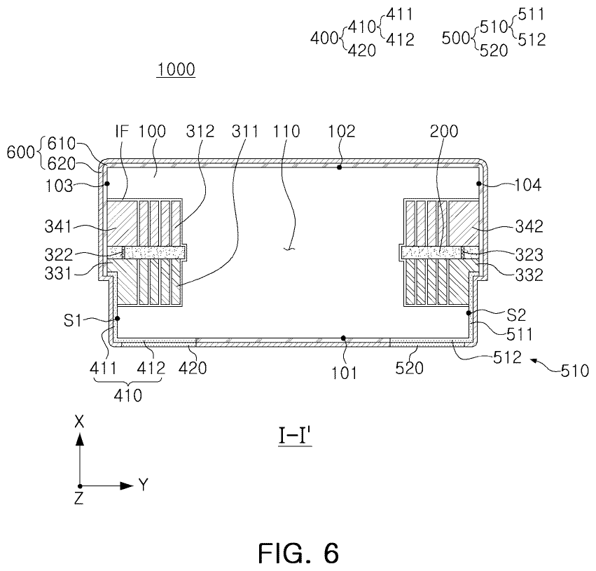

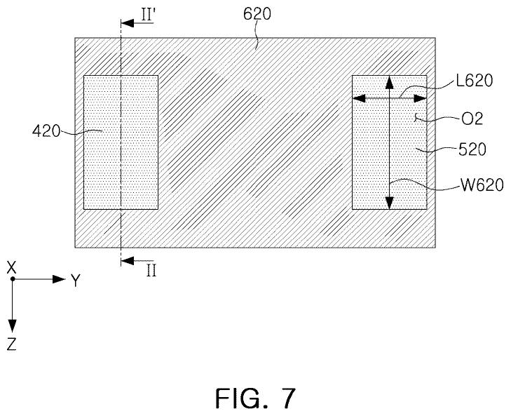

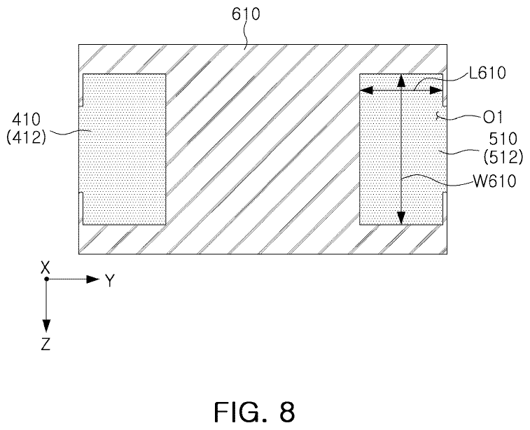

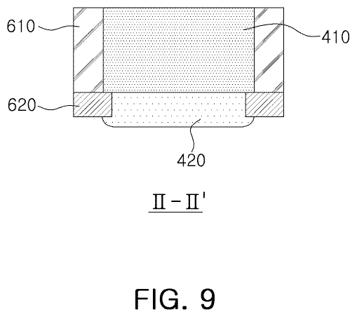

FIG. 1 is a diagram schematically illustrating a coil component according to a first embodiment of the present disclosure. FIG. 2 is a bottom view of a coil component according to the first embodiment of the present disclosure. FIG. 3 is a diagram illustrating that a second insulating layer and a second metal layer are omitted in FIG. 2. FIG. 4 is a diagram illustrating that a first insulating layer is omitted in FIG. 3. FIG. 5 is a diagram illustrating that a first metal layer is omitted in FIG. 4. FIG. 6 is a cross-sectional view taken along line I-I′ of FIG. 1. FIG. 7 is a diagram illustrating that FIG. 1 is viewed in a first direction. FIG. 8 is a diagram illustrating that a second insulating layer and a second metal layer are omitted in FIG. 7. FIG. 9 is a cross-sectional view taken along line II-II′ of FIG. 7.

Referring to FIGS. 1 to 9, a coil component 1000 according to the first embodiment of the present disclosure may include a body 100, a coil 300, external electrodes 400 and 500, and insulating layers 610 and 620 and may further include a support member 200 and an insulating film IF.

The body 100 forms an external casing of the coil component 1000 according to the present embodiment, and the coil 300 is disposed therein.

The body 100 may be formed in the shape of a hexahedron as a whole.

With respect to the directions of FIGS. 1 to 6, the body 100 includes a first surface 101 and a second surface 102 opposing each other in the first direction (the X-direction), a third surface 103 and a fourth surface 104 opposing each other in the second direction (the Y-direction), and a fifth surface 105 and a sixth surface 106 opposing each other in the third direction (the Z-direction). Each of the third to sixth surfaces 103, 104, 105, and 106 of the body 100 corresponds to a side surface of the body 100 that connects the first surface 101 and the second surface 102 of the body 100. Hereinafter, both end surfaces (one end surface and the other end surface) of the body 100 may refer to the third surface 103 and the fourth surface 104 of the body, respectively, both side surfaces (one side surface and the other side surface) of the body 100 may refer to the fifth surface 105 and the sixth surface 106 of the body, and one surface of the body 100 may refer to the first surface 101 of the body 100, and the other surface of the body 100 may refer to the second surface 102 of the body 100.

The body 100 may be formed, for example, so that the coil component 1000 according to the present embodiment, in which the external electrodes 400 and 500 and the insulating layers 610 and 620 described below are formed, has a length of 2.0 mm, a width of 1.2 mm, and a thickness of 0.65 mm, but is not limited thereto. Meanwhile, the aforementioned numerical values are only numerical design values not reflecting process errors, etc., and thus, it should be considered that the range that may be admitted as process errors falls within the scope of the present disclosure.

The length of the coil component 1000 described above may refer to, based on an optical microscope or scanning electron microscope (SEM) photograph of a cross-section in the length direction (the Y-direction)-thickness direction (the X-direction) at the central portion of the coil component 1000 in the width direction (the Z-direction), the maximum value among the respective lengths of a plurality of line segments that connect two boundary lines opposing each other in the length direction (the Y-direction) among the outermost boundary lines of the coil component 1000 shown in the cross-section photograph and are parallel to the length direction (the Y-direction). Alternatively, the length of the coil component 1000 may refer to the minimum value among the respective lengths of a plurality of line segments that connect two boundary lines opposing each other in the length direction (the Y-direction) among the outermost boundary lines of the coil component 1000 shown in the cross-section photograph and are parallel to the length direction (the Y-direction). Alternatively, the length of the coil component 1000 may refer to an arithmetic mean value of at least two of the respective lengths of a plurality of line segments that connect two boundary lines opposing each other in the length direction (the Y-direction) among the outermost boundary lines of the coil component 1000 shown in the cross-section photograph and are parallel to the length direction (the Y-direction).

The thickness of the coil component 1000 described above may refer to, based on an optical microscope or scanning electron microscope (SEM) photograph of a cross-section in the length direction (the Y-direction)-thickness direction (the X-direction) at the central portion of the coil component 1000 in the width direction (the Z-direction), the maximum value among the respective lengths of a plurality of line segments that connect two boundary lines opposing each other in the thickness direction (the X-direction) among the outermost boundary lines of the coil component 1000 shown in the cross-section photograph and are parallel to the thickness direction (the X-direction). Alternatively, the thickness of the coil component 1000 may refer to the minimum value among the respective lengths of a plurality of line segments that connect two boundary lines opposing each other in the thickness direction (the X-direction) among the outermost boundary lines of the coil component 1000 shown in the cross-section photograph and are parallel to the thickness direction (the X-direction). Alternatively, the thickness of the coil component 1000 may refer to an arithmetic mean value of at least two of the respective lengths of a plurality of line segments that connect two boundary lines opposing each other in the thickness direction (the X-direction) among the outermost boundary lines of the coil component 1000 shown in the cross-section photograph and are parallel to the thickness direction (the X-direction).

The width of the coil component 1000 described above may refer to, based on an optical microscope or scanning electron microscope (SEM) photograph of a cross-section in the length direction (the Y-direction)-width direction (the Z-direction) at the central portion of the coil component 1000 in the thickness direction (the X-direction), the maximum value among the respective lengths of a plurality of line segments that connect two boundary lines opposing each other in the width direction (the Z-direction) among the outermost boundary lines of the coil component 1000 shown in the cross-section photograph and are parallel to the width direction (the Z-direction). Alternatively, the width of the coil component 1000 may refer to the minimum value among the respective lengths of a plurality of line segments that connect two boundary lines opposing each other in the width direction (the Z-direction) among the outermost boundary lines of the coil component 1000 shown in the cross-section photograph and are parallel to the width direction (the Z-direction). Alternatively, the width of the coil component 1000 may refer to an arithmetic mean value of at least two of the respective lengths of a plurality of line segments that connect two boundary lines opposing each other in the width direction (the Z-direction) among the outermost boundary lines of the coil component 1000 shown in the cross-section photograph and are parallel to the width direction (the Z-direction).

Alternatively, the length, width, and thickness of the coil component 1000 may be measured by a micrometer measurement method. According to the micrometer measurement method, the length, width, and thickness of the coil component 1000 may be measured by setting the zero point with a Gage R&R (Repeatability and Reproducibility) micrometer, inserting the coil component 1000 according to the present embodiment between tips of the micrometer, and turning a measurement lever of the micrometer. Meanwhile, when measuring the length of the coil component 1000 by the micrometer measurement method, the length of the coil component 1000 may refer to a value measured once or may refer to an arithmetic average of values measured a plurality of times. This may be equally applied to the width and thickness of the coil component 1000.

The body 100 may include a magnetic material and a resin. Specifically, the body 100 may be formed by stacking one or more magnetic composite sheets in which the magnetic material is dispersed in the resin. However, the body 100 may have a structure other than the structure in which the magnetic material is dispersed in the resin. For example, the body 100 may be formed of a magnetic material, such as ferrite.

The magnetic material may include ferrite or a magnetic metal powder particle.

Ferrites may include at least one selected from the group consisting of, for example, spinel-type ferrites, such as Mg—Zn-based, Mn—Zn-based, Mn—Mg-based, Cu—Zn-based, Mg—Mn-Sr-based, Ni—Zn-based ferrites, hexagonal ferrites, such as Ba—Zn-based, and Ba—Mg-based, Ba—Ni-based, Ba—Co-based, and Ba—Ni-Co-based ferrites, and a garnet-type ferrite, such as Y-based ferrite, and Li-based ferrite.

The magnetic metal powder particle may include at least one selected from the group consisting of iron (Fe), silicon (Si), chromium (Cr), cobalt (Co), molybdenum (Mo), aluminum (Al), niobium (Nb), copper (Cu), and nickel (Ni). For example, the magnetic metal powder particle may be at least one of pure iron powder particle, Fe—Si alloy powder particle, Fe—Si—Al alloy powder particle, Fe—Ni alloy powder particle, Fe—Ni—Mo alloy powder particle, Fe—Ni—Mo—Cu alloy powder particle, Fe—Co alloy powder particle, Fe—Ni—Co alloy powder particle, Fe—Cr alloy powder particle, Fe—Cr—Si alloy powder particle, Fe—Si—Cu—Nb alloy powder particle, Fe—Ni—Cr alloy powder particle, and Fe—Cr—Al alloy powder particle.

The magnetic metal powder particle may be amorphous or crystalline. For example, the magnetic metal powder particle may be an Fe—Si—B—Cr amorphous alloy powder particle, but is not necessarily limited thereto.

The ferrite and the magnetic metal powder particle may each have an average diameter of about 0.1 μm to 30 μm, but is not limited thereto. Meanwhile, the average diameter of the magnetic metal powder particle may refer to a particle size distribution expressed as D50 or D90.

The body 100 may include two or more types of magnetic materials dispersed in a resin. Here, the magnetic materials being of different types refer to that the magnetic materials dispersed in the resin are distinguished from each other by any one of the average diameter, composition, crystallinity, and shape.

The resin may include an epoxy, a polyimide, a liquid crystal polymer, etc. alone or in combination, but is not limited thereto.

The body 100 includes a core 110 penetrating through the central portion of each of the support member 200 and the coil 300 described below. The core 110 may be formed by filling a through-hole penetrating through the central portion of each of the coil 300 and the support member 200 with a magnetic composite sheet, but is not limited thereto.

A recess may be formed on at least one or each of the third surface 103 and the fourth surface 104 of the body 100. Specifically, a first recess S1 may be formed at the edge between the first surface 101 and the third surface 103 of the body 100, and a second recess S2 may be formed at an edge between the first surface 101 and the fourth surface 104 of the body 100. Meanwhile, the first and second recesses S1 and S2 are formed with a depth (which may refer to dimensions of the first and second recesses S1 and S2 in the thickness direction (X-direction)) that allows lead patterns 331 and 332 described below to be exposed to internal surfaces of the first and second recesses S1 and S2, but the first and second recesses S1 and S2 may not extend to the second surface 102 of the body 100. That is, the first and second recesses S1 and S2 may not penetrate through the body 100 in the thickness direction (the X-direction).

The first and second recesses S1 and S2 may extend to the fifth and sixth surfaces 105 and 106 of the body 100 in the width direction (the Z-direction) of the body 100, respectively. That is, the first and second recesses S1 and S2 may be in the form of slits formed entirely in the width direction (the Z-direction) of the body 100. The first and second recesses S1 and S2 may be formed by performing pre-dicing on one surface of a coil bar along a boundary line that coincides with the width direction of each coil component among the boundary lines individualizing each coil component at the coil bar level before each coil component is individualized. A depth of this pre-dicing is adjusted so that the lead patterns 331 and 332 are exposed.

Meanwhile, internal surfaces (inner walls and bottom surfaces) of the recesses S1 and S2 also constitute the surface of the body 100, but in this disclosure, for the convenience of description, the internal surfaces of the recesses S1 and S2 are distinguished from the surface of the body 100. In addition, in FIGS. 1 to 7, the first and second recesses S1 and S2 are illustrated as having inner walls parallel to the third and fourth surfaces 103 and 104 of the body 100 and bottom surfaces parallel to the first and second surfaces 101 and 102 of the body 100, but this is for the convenience of description, and the scope of the present embodiment is not limited thereto. For example, the first recess S1 may be formed to have a curved shape with an internal surface connecting the first surface 101 and the third surface 103 of the body 100 based on the length direction (the Y-direction)-thickness direction (the X-direction) cross-section of the coil component 1000 according to the present embodiment. However, for convenience of description, it will be described below that the recesses S1 and S2 have an inner wall and a bottom surface.

Meanwhile, the recesses S1 and S2 may not be formed on the third surface 103 and the fourth surface 104 of the body 100. In this case, first metal layers 410 and 510 of the external electrodes 400 and 500 described below may not be formed on the internal surfaces of the recesses S1 and S2, but may be formed on the third surface 103 and the fourth surface 104 of the body 100 instead.

The support member 200 is disposed inside the body 100. The support member 200 is configured to support the coil 300 to be described below.

The support member 200 may be formed of an insulating material including a thermosetting insulating resin, such as an epoxy resin, a thermoplastic insulating resin, such as a polyimide, or a photosensitive insulating resin or may include an insulating material in which a reinforcing material, such as glass fiber or an inorganic filler is impregnated into the insulating resin. For example, the support member 200 may include an insulating material, such as a prepreg, an Ajinomoto build-up film (ABF), FR-4, a bismaleimide triazine (BT) resin, a photo imageable dielectric (PID), or may include a metal laminate, such as a copper clad laminate (CCL), but is not limited thereto.

The inorganic filler may include at least one selected from the group consisting of silica (SiO₂), alumina (Al₂O₃), silicon carbide (SiC), barium sulfate (BaSO₄), talc, clay, mica powder particles, aluminum hydroxide (Al(OH)₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃), and calcium zirconate (CaZrO₃).

When the support member 200 includes an insulating material including a reinforcing material, the support member 200 may provide better rigidity. When the support member 200 is formed of an insulating material not including glass fiber, it is advantageous in reducing the thickness of the coil component 1000 according to the present embodiment. In addition, based on the body 100 of the same size, the volume occupied by the coil 300 and/or the magnetic material may be increased, thereby improving the component characteristics. When the support member 200 includes an insulating material including a photosensitive insulating resin, the number of processes for forming the coil 300 may be reduced, which is advantageous in reducing production costs, and allows the formation of fine vias.

The coil 300 is disposed inside the body 100 and demonstrates the characteristics of the coil component. For example, when the coil component 1000 of the present embodiment is utilized as a power inductor, the coil 300 may store an electric field as a magnetic field to maintain an output voltage, thereby stabilizing power of the electronic device.

The coil 300 includes coil patterns 311 and 312, vias 321, 322, and 323, lead patterns 331 and 332, and sub-lead patterns 341 and 342. Specifically, based on the directions of FIGS. 1 to 6, a first coil pattern 311, a first lead pattern 331, and a second lead pattern 332 may be arranged on a lower surface of the support member 200 facing the first surface 101 of the body 100, and a second coil pattern 312, a first sub-lead pattern 341, and a second sub-lead pattern 342 may be arranged on an upper surface of the support member 200 facing the lower surface of the support member 200. On the lower surface of the support member 200, the first coil pattern 311 may be spaced apart from the second lead pattern 332 and may be in contact with the first lead pattern 331. On the upper surface of the support member 200, the second coil pattern 312 may be spaced apart from the first sub-lead pattern 341 and may be in contact with the second sub-lead pattern 342. A first via 321 penetrates through the support member 200 and contacts and is connected to an inner end of each of the first coil pattern 311 and the second coil pattern 312. A second via 322 penetrates through the support member 200 and contacts and is connected to each of the first lead pattern 331 and the first sub-lead pattern 341. The third via 323 penetrates through the support member 200 and contacts and is connected to each of the second lead pattern 332 and the second sub-lead pattern 342. Accordingly, the coil 300 may function as one coil as a whole. Each of the first coil pattern 311 and the second coil pattern 312 may be in the form of a planar spiral forming at least one turn with the core 110 as an axis. For example, the first coil pattern 311 may form at least one turn with the core 110 as an axis on the lower surface of the support member 200.

The first lead pattern 331 and the second lead pattern 332 may extend to the internal surfaces of the first and second recesses S1 and S2. Specifically, the first lead pattern 331 may extend to the internal surface of the first recess S1, and the second lead pattern 332 may extend to the internal surface of the second recess S2. Since connection portions 411 and 511 of the external electrodes 400 and 500 to be described below are arranged in the first and second recesses S1 and S2, the coil 300 and the external electrodes 400 and 500 contact and are connected to each other. Meanwhile, for convenience of description, as shown in FIGS. 5 and 6, it is described on the premise that the first and second recesses S1 and S2 are formed to extend to the inside of at least a portion of each of the lead patterns 331 and 332, so that the lead patterns 331 and 332 are exposed to the inner walls and bottom surfaces of the first and second recesses S1 and S2, respectively. However, this is merely an example, and the scope of the present embodiment is not limited thereto. That is, the depth of the first and second recesses S1 and S2 may be adjusted so that the lead patterns 331 and 332 are exposed only to the bottom surfaces of the first and second recesses S1 and S2. Meanwhile, when the lead patterns 331 and 332 are exposed to both the bottom surfaces and the inner walls of the first and second recesses S1 and S2, the contact area between the lead patterns 331 and 332 and the connection portions 411 and 511 of the external electrodes 400 and 500 may increase, so that bonding force between the coil 300 and the external electrodes 400 and 500 may increase.

One surface of the lead patterns 331 and 332 extending to the internal surfaces of the first and second recesses S1 and S2 may have a higher surface roughness than the other surface of the lead patterns 331 and 332. For example, when forming the first and second recesses S1 and S2 after forming the lead patterns 331 and 332 by electroplating, a portion of each of the lead patterns 331 and 332 may be removed in the recess forming process. As a result, one surface of the lead patterns 331 and 332 exposed to the internal surface of the first and second recesses S1 and S2 is formed to have higher surface roughness than the remaining surface of the lead patterns 331 and 332 due to polishing of a dicing tip. As described below, the external electrodes 400 and 500 are formed as thin films and thus may have relatively weak bonding strength with the coil 300. However, since the external electrodes 400 and 500 contact and are connected to one surface of the lead patterns 331 and 332 having relatively high surface roughness, the bonding strength between the external electrodes 400 and 500 and the lead patterns 331 and 332 may be improved.

The lead patterns 331 and 332 and the sub-lead patterns 341 and 342 may extend to the third surface 103 and the fourth surface 104 of the body 100, respectively. That is, the first lead pattern 331 may extend to the third surface 103 of the body 100, and the second lead pattern 332 may extend to the fourth surface 104 of the body 100. The first sub-lead pattern 341 may extend to the third surface 103 of the body 100, and the second sub-lead pattern 342 may extend to the fourth surface 104 of the body 100. Accordingly, as shown in FIGS. 5 and 6, the first lead pattern 331 may extend continuously to the inner wall of the first recess S1, the bottom surface of the first recess S1, and the third surface 103 of the body 100, and the second lead pattern 332 may extend continuously to the inner wall of the second recess S2, the bottom surface of the second recess S2, and the fourth surface 104 of the body 100.

At least one of the coil patterns 311 and 312, the vias 321, 322, and 323, the lead patterns 331 and 332, and the sub-lead patterns 341 and 342 may include at least one conductive layer.

For example, when the second coil pattern 312, the sub-lead patterns 341 and 342, and the vias 321, 322, and 323 are formed by performing plating on the upper surface side of the support member 200, the second coil pattern 312, the sub-lead patterns 341 and 342, and the vias 321, 322, and 323 may each include a seed layer and an electroplated layer. Here, the electroplated layer may have a single-layer structure or a multi-layer structure. The multilayer electroplated layer may be formed as a conformal film structure in which another electroplated layer is formed along a surface of one electroplated layer or may be formed in a shape in which another electroplated layer is stacked on only one surface of one electroplated layer. The seed layer may be formed by an electroless plating method or a vapor deposition method, such as sputtering. The seed layer of the second coil pattern 312, the seed layer of the sub-outlet patterns 341 and 342, and the seed layer of the vias 321, 322, and 323 may be formed integrally so that no boundary may be formed therebetween, but is not limited thereto. The electroplated layer of the second coil pattern 312, the electroplated layer of the sub-outlet patterns 341 and 342, and the electroplated layer of the vias 321, 322, and 323 may be formed integrally so that no boundary may be formed therebetween, but is not limited thereto.

As another example, when the first coil pattern 311 and the lead patterns 331 and 332 arranged on the lower surface side of the support member 200 and the second coil pattern 312 and the sub-lead patterns 341 and 342 arranged on the upper surface side of the support member 200 are formed separately from each other and then are collectively stacked on the support member 200 to form the coil 300, the vias 321, 322, and 323 may include a high-melting-point metal layer and a low-melting-point metal layer having a melting point lower than that of a melting point of the high-melting-point metal layer. Here, the low-melting-point metal layer may be formed of a solder including lead (Pb) and/or tin (Sn). The low melting point metal layer may be at least partially melted due to pressure and temperature during the collective stacking, so that, for example, an intermetallic compound (IMC) layer may be formed at the boundary between the low-melting-point metal layer and the second coil pattern 312.

The coil patterns 311 and 312, the lead patterns 331 and 332, and the sub-lead patterns 341 and 342 may be formed to protrude from the lower and upper surfaces of the support member 200, as shown in FIG. 6, for example. As another example, the first coil pattern 311 and the lead patterns 331 and 332 may be formed to protrude from the lower surface of the support member 200, and the second coil pattern 312 and the sub-lead patterns 341 and 342 may be embedded in the upper surface of the support member 200 so that the upper surfaces of the second coil pattern 312 and the sub-lead patterns 341 and 342 may be exposed to the upper surface of the support member 200. In this case, a concave portion may be formed on the upper surface of the second coil pattern 312 and/or the upper surfaces of the sub-lead patterns 341 and 342, so that the upper surface of the support member 200, the upper surface of the second coil pattern 312 and/or the upper surfaces of the sub-lead patterns 341 and 342 may not be located on the same plane. Each of the coil patterns 311 and 312, vias 321, 322, and 323, lead patterns 331 and 332, and sub-lead patterns 341 and 342 may include a conductive material, such as copper (Cu), aluminum (Al), silver (Ag), tin (Sn), gold (Au), nickel (Ni), lead (Pb), titanium (Ti), chromium (Cr), or alloys thereof, but is not limited thereto.

The external electrodes 400 and 500 are arranged spaced apart from each other on the first surface 101 of the body and extend to the first and second recesses S1 and S2, respectively, to contact the first and second lead patterns 331 and 332. In the present embodiment, the first external electrode 400 includes a first metal layer 410 and a second metal layer 420, and the second external electrode 500 includes a first metal layer 510 and a second metal layer 520. The first metal layers 410 and 510 include connection portions 411 and 511 disposed in the recesses S1 and S2 and contacting the lead patterns 331 and 332 exposed to the internal surfaces of the recesses S1 and S2, and pad portions 412 and 512 arranged on the first surface 101 of the body 100. The second metal layers 420 and 520 are disposed on the pad portions 412 and 512 of the first metal layers 410 and 510, respectively.

Specifically, the first metal layer 410 of the first external electrode 400 includes a first connection portion 411 disposed on the bottom surface and inner wall of the first recess S1 and contacting and connected to the first lead pattern 331 of the coil 300 and a first pad portion 412 disposed on the first surface 101 of the body 100, and the second metal layer 420 of the first external electrode 400 is disposed on the first pad portion 412 of the first metal layer 410. The first metal layer 510 of the second external electrode 500 includes a second connection portion 511 disposed on the bottom surface and inner wall of the second recess S2 and contacting and connected to the second lead pattern 332 of the coil 300 and a second pad portion 512 disposed on the first surface 101 of the body 100, and the second metal layer 520 of the second external electrode 500 is disposed on the second pad portion 512 of the first metal layer 510.

The pad portions 412 and 512 of the external electrodes 400 and 500 are arranged to be spaced apart from each other in the second direction (the Y-direction) on the first surface 101 of the body 100, and the second metal layers 420 and 520 of the external electrodes 400 and 500 are arranged to be spaced apart from each other in the second direction (the Y-direction) on the first surface 101 of the body 100.

The first metal layers 410 and 510 are formed on the bottom surfaces and inner walls of the recesses S1 and S2 and the first surface 101 of the body 100. That is, the first metal layers 410 and 510 are formed as conformal films on the internal surfaces of the recesses S1 and S2 and the first surface 101 of the body 100. The connection portions 411 and 511 and the pad portions 412 and 512 of the first metal layers 410 and 510 may be formed together during the same process and may be integrally formed on the internal surfaces of the recesses S1 and S2 and the first surface 101 of the body 100. That is, a boundary may not be formed between the connection portions 411 and 511 and the pad portions 412 and 512.

Meanwhile, as described above, the recesses S1 and S2 may not be formed on the third surface 103 and the fourth surface 104 of the body 100. In this case, the first metal layers 410 and 510 may be formed on the third surface 103 and the fourth surface 104 of the body 100 and may be connected to the lead patterns 331 and 332 of the coil.

The connection portions 411 and 511 may be arranged in the center of the first and second recesses S1 and S2 so as to be spaced apart from the fifth and sixth surfaces 105 and 106 of the body 100, respectively. That is, the connection portions 411 and 511 may be arranged in the center of the internal surfaces of the first and second recesses S1 and S2 in the Z-direction (the third direction). Since the lead patterns 331 and 332 are exposed in the center of the internal surfaces of the first and second recesses S1 and S2 in the Z-direction (the third direction), the connection portions 411 and 511 may be formed only in the region of the internal surfaces of the first and second recesses S1 and S2 in which the lead patterns 331 and 332 are exposed.

The pad portions 412 and 512 may be arranged on the first surface 101 of the body 100 so as to be spaced apart from the fifth and sixth surfaces 105 and 106 of the body 100, respectively. In this case, the coil component 1000 according to the present embodiment may be prevented from being short-circuited with other components mounted on the outside of a mounting board, etc. in the Z-direction (the third direction).

At least one of the distances from the fifth and sixth surfaces 105 and 106 of the body 100 to the pad portions 412 and 512 may be shorter than at least one of the distances from the fifth and sixth surfaces 105 and 106 of the body 100 to the connection portions 411 and 511, respectively. For example, as illustrated in FIG. 4, a length d1 of the connection portions 411 and 511 in the Z-direction (the third direction) may be less than a length d2 of the pad portions 412 and 512 in the Z-direction (the third direction). The first surface 101 of the body 100 may be used as a mounting surface when the coil component 1000 according to the present embodiment is mounted on a mounting board, etc., and the second metal layers 420 and 520 arranged on the pad portions 412 and 512 of the external electrodes 400 and 500 may be connected to a connection pad of the mounting board through a bonding member, such as solder. In this case, since the length d2 of the pad portions 412 and 512 in the Z-direction (the third direction) is longer than the length d1 of the connection portions 411 and 511 in the Z-direction (the third direction), the length of the second metal layers 420 and 520 in contact with a bonding member, such as solder, in the Z-direction (the third direction) may increase. In addition, since the length d1 of the connection portions 411 and 511 in the Z-direction (the third direction) is shorter than the length d2 of the pad portions 412 and 512 in the Z-direction (the third direction), a short-circuit with other components mounted adjacent to the mounting board in the Y-direction (the second direction) may be prevented. That is, among the components of the external electrodes 400 and 500, the size (the length d1 in the Z-direction (the third direction)) of the connection portions 411 and 511 disposed closest to other components in the Y-direction (the second direction) when mounted may be formed small, thereby reducing the possibility of a short-circuit with other components.

The second metal layers 420 and 520 are disposed on the pad portions 412 and 512. Specifically, the second metal layer 420 of the first external electrode 400 is disposed on the first pad portion 412, and the second metal layer 520 of the second external electrode 500 is disposed on the second pad portion 512. The second metal layers 420 and 520 may be formed in a single-layer or multi-layer structure. For example, the second metal layers 420 and 520 are formed by sequentially plating on the pad portions 412 and 512 including copper (Cu) and may include a nickel (Ni) plating layer and a tin (Sn) plating layer including nickel (Ni) and tin (Sn), respectively, but is not limited thereto.

The external electrodes 400 and 500 may be formed by a vapor deposition method, such as sputtering, and/or a plating method, but is not limited thereto.

The external electrodes 400 and 500 may include a conductive material, such as copper (Cu), aluminum (Al), silver (Ag), tin (Sn), gold (Au), nickel (Ni), lead (Pb), chromium (Cr), titanium (Ti), or alloys thereof, but is not limited thereto.

The insulating film IF is disposed between the coil 300 and the body 100 and between the support member 200 and the body 100. The insulating film IF may be formed on the surfaces of the lead patterns 331 and 332, the coil patterns 311 and 312, the sub-lead patterns 341 and 342, and the support member 200, but is not limited thereto. The insulating film IF is for insulating the coil 300 and the body 100 and may include a known insulating material, such as parylene, but is not limited thereto. As another example, the insulating film IF may include an insulating material, such as an epoxy resin, other than parylene. The insulating film IF may be formed by a vapor deposition method but is not limited thereto. As another example, the insulating film IF may be formed by stacking and curing an insulating film for forming the insulating film IF on both surfaces of the support member 200 on which the coil 300 is formed or by applying and curing an insulating paste for forming the insulating film IF on both surfaces of the support member 200 on which the coil 300 is formed. Meanwhile, for the above-mentioned reason, the insulating film IF is a component that may be omitted in the present embodiment. That is, if the body 100 has sufficient electrical resistance at a designed operating current and voltage of the coil component 1000 according to the present embodiment, the insulating film IF may be omitted in the present embodiment.

FIG. 7 is a diagram illustrating FIG. 1 as viewed in the first direction. FIG. 8 is a diagram illustrating that the second insulating layer and the second metal layer are omitted in FIG. 7.

The first insulating layer 610 is disposed on the first surface 101 of the body 100, and a first opening O1 is formed. Referring to FIG. 8, the pad portions 412 and 512 are disposed in the first opening O1, so that the first insulating layer 610 exposes the first metal layers 410 and 510. The first insulating layer 610 is disposed on the outer side of both ends of the pad portions 412 and 512 in the Z-direction (the third direction), so that the pad portions 412 and 512 may be spaced apart from the fifth surface 105 and the sixth surface 106 of the body 100, respectively. The first insulating layer 610 may be disposed on the second to sixth surfaces 102, 103, 104, 105, and 106 of the body 100 and also on the recesses S1 and S2. When the first insulating layer 610 is disposed on the recesses S1 and S2, the connection portions 411 and 511 are exposed. That is, the first insulating layer 610 may be disposed only in a region of the internal surfaces of the recesses S1 and S2 in which the connection portions 411 and 511 are not disposed.

The first insulating layer 610 may be formed on the surface of the body 100 before the first metal layers 410 and 510 are formed, for example. Accordingly, the first insulating layer 610 may function as a mask when selectively forming the first metal layers 410 and 510 on the first surface 101 of the body 100 and the internal surfaces of the first and second recesses S1 and S2. For example, the first insulating layer 610 may function as a plating resist when forming the first metal layers 410 and 510 by a plating method.

The first insulating layer 610 may be formed in a state in which each coil component is individualized. That is, the process of forming the first insulating layer 610 may be performed after the pre-dicing process and the individualization process (full dicing process) described above. After each coil component is individualized by the full dicing process, drum coating may be performed on each coil component to form the first insulating layer 610 on the entire surface of the body 100. Unlike processes, such as screen-printing, drum coating may insulate the entire external surface of the body in one process, so that the insulation thickness of the external surface of the body may be uniformized and thinned. After drum coating, the first opening O1 of the first insulating layer 610 may be formed using a process, such as laser etching.

At least a portion of the external electrodes 400 and 500 may be disposed in the first opening O1. Specifically, at least a portion of the first metal layers 410 and 510 may be disposed in the first opening O1, and more specifically, at least a portion of the pad portions 412 and 512 may be disposed in the first opening O1.

The first insulating layer 610 may be disposed to surround the first metal layers 410 and 510. Specifically, the first insulating layer 610 may be disposed to surround the edge of the pad portions 412 and 512. Meanwhile, the first metal layers 410 and 510 may include the connection portions 411 and 511, and the connection portions 411 and 511 may extend from the pad portions 412 and 512 to the internal surfaces of the recesses S1 and S2, so that the first insulating layer 610 may surround the edges of the pad portions 412 and 512 except for the portion connected to the connection portions 411 and 511.

The first insulating layer 610 may include a thermoplastic resin, such as polystyrene, vinyl acetate, polyester, polyethylene, polypropylene, polyamide, rubber, acrylic, etc., a thermosetting resin, such as phenol, epoxy, urethane, melamine, alkyd, etc., a photosensitive resin, parylene, SiOₓ, or SiNₓ. The first insulating layer 610 may further include an insulating filler, such as an inorganic filler, but is not limited thereto.

The second insulating layer 620 is disposed on the first insulating layer 610 disposed on the first surface 101 of the body 100. A second opening O2 is formed in the second insulating layer 620. Referring to FIG. 7, the second metal layers 420 and 520 are disposed in the second opening O2, so that the second insulating layer 620 exposes the second metal layers 420 and 520. The second insulating layer 620 may be disposed on the outer side of both ends of each of the second metal layers 420 and 520 in the Z-direction (the third direction) so that the second metal layers 420 and 520 may be spaced apart from the fifth and sixth surfaces 105 and 106 of the body 100, respectively.

The second insulating layer 620 may cover the first metal layers 410 and 510 and the first insulating layer 610 disposed on the second to sixth surfaces 102, 103, 104, 105, and 106 of the body. Specifically, since the second insulating layer 620 may cover the connection portions 411 and 511 arranged on the internal surfaces of the recesses S1 and S2, the connection portions 411 and 511 may not be exposed to the outside of the component.

The second insulating layer 620 may be formed on the first insulating layer 610 before the second metal layers 420 and 520 are formed, for example. Therefore, the second insulating layer 620 may function as a mask when selectively forming the second metal layers 420 and 520 on the first surface 101 of the body 100. For example, the second insulating layer 620 may function as a plating resist when forming the second metal layers 420 and 520 by plating.

The second insulating layer 620 may be formed by performing drum coating while the first insulating layer 610 and the first metal layers 410 and 510 are formed. Unlike processes, such as screen-printing, drum coating may insulate the entire external surface of the body in one process, so the insulation thickness of the external surface of the body may be uniformized and thinned. After drum coating, the second opening O2 of the second insulating layer 620 may be formed using a process, such as laser etching.

At least a portion of the external electrodes 400 and 500 may be disposed in the second opening O2. Specifically, at least a portion of the second metal layers 420 and 520 may be disposed in the second opening O2. The second insulating layer 620 may be disposed to surround the second metal layers 420 and 520.

The second insulating layer 620 may include a thermoplastic resin, such as polystyrene, vinyl acetate, polyester, polyethylene, polypropylene, polyamide, rubber, acrylic, etc., a thermosetting resin, such as phenol, epoxy, urethane, melamine, alkyd, etc., a photosensitive resin, parylene, SiOₓ, or SiNₓ. The second insulating layer 620 may further include an insulating filler, such as an inorganic filler, but is not limited thereto.

The second insulating layer 620 may include a different material from that of the first insulating layer 610, but is not necessarily limited thereto.

Referring to FIGS. 7 and 8, the sizes of the first opening O1 and the second opening O2 may be different. For example, a length L610 of the first opening O1 in the second direction (the Y-direction) may be greater than a length L620 of the second opening O2 in the second direction (the Y-direction). Alternatively, a length W610 of the first opening O1 in the third direction (the Z-direction) may be greater than a length W620 of the second opening O2 in the third direction (the Z-direction). The different sizes of the first opening O1 and the second opening O2 may be sufficient and it is not necessary to satisfy the both conditions regarding the length in the second direction (the Y-direction) and the length in the third direction (the Z-direction).

In the case of a power inductor having a bottom electrode structure, as the coil component becomes thinner and smaller, plating spreading defects that an electrode formed on a bottom surface of a component spreads to an upper surface of the component may occur. The coil component according to the present embodiment may improve the plating spread defects by introducing the first insulating layer 610 and the second insulating layer 620 each having an opening formed therein and disposing the plating layers of the external electrodes in the openings O1 and O2.

FIG. 9 is a cross-sectional view taken along line II-II′ of FIG. 7.

Referring to FIG. 9, the first insulating layer 610 and the second insulating layer 620 may be formed so that the openings O1 and O2 are stepped. For example, at least a portion of the second insulating layer 620 may extend to the upper surface of the first metal layer 410. This allows the second metal layer 420 to be controlled from being disposed in an unintended region during plating and improves the plating spreading phenomenon. In addition, the end of the second metal layer 420 may be in contact with the bonding member, such as a solder, so that the mounting stability of the coil component may be improved.

### Modified Example of the First Embodiment

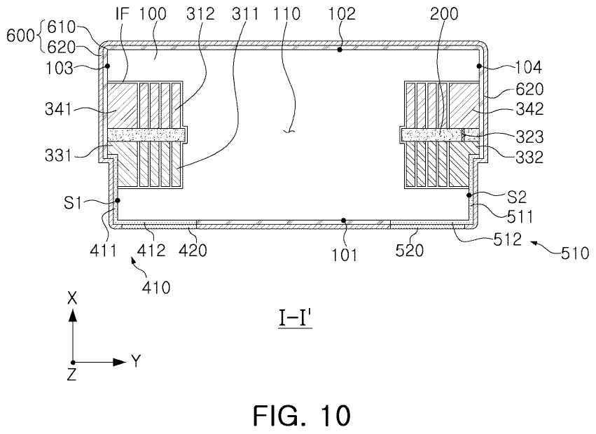

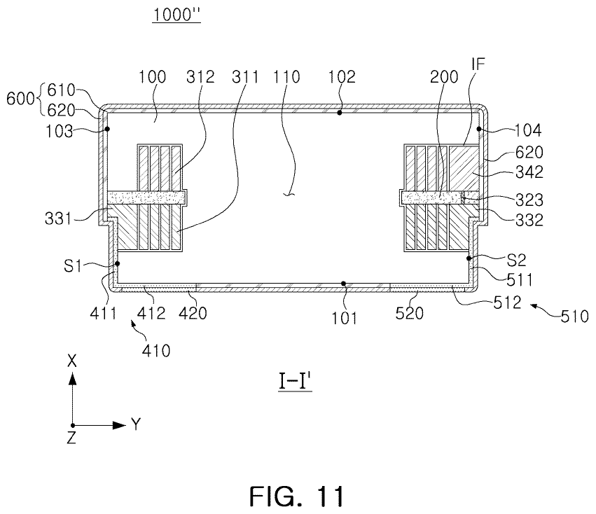

FIGS. 10 and 11 are diagrams schematically illustrating modified examples of the coil component according to the first embodiment of the present disclosure, respectively, and are diagrams corresponding to FIG. 6.

Referring to FIG. 10, in the case of one modified example of the first embodiment of the present disclosure, the second via 322 described above may be omitted. That is, referring to FIG. 10, the first sub-lead pattern 341 is unrelated to the electrical connection between the coil 300 and the external electrodes 400 and 500, and thus, in this modified example, the second via 322 for connection between the first lead pattern 331 and the first sub-lead pattern 341 is omitted. However, in this modified example, since the first sub-lead pattern 341 is not omitted, warpage of the support member 200 during the process may be minimized.

Referring to FIG. 11, in the case of another modified example of the first embodiment of the present disclosure, the second via 322 is omitted as in the modified example illustrated in FIG. 10, and in addition, the first sub-lead pattern 341 may be omitted. In this modified example, the effective volume of the magnetic material of the body 100 may be increased by a volume corresponding to the volume of the first sub-extraction pattern 34.

According to the embodiments of the present disclosure, the insulation thickness of the coil component may be uniformized, thereby improving the effective volume of the magnetic body.

In addition, according to the embodiments of the present disclosure, the plating spreading phenomenon may be controlled when plating the external electrodes of the coil component.

While example embodiments have been shown and described above, it will be apparent to those skilled in the art that modifications and variations could be made without departing from the scope of the present disclosure as defined by the appended claims.

What is claimed is:

1. A coil component comprising:
a body including: a first surface and a second surface opposing each other in a first direction; a third surface and a fourth surface opposing each other in a second direction and each having a recess formed therein; and a fifth surface and a sixth surface opposing each other in a third direction;
a coil disposed within the body and having both ends extending to the recesses;
an external electrode disposed on the first surface of the body and extending to the recesses so as to be connected to both ends of the coil;
a first insulating layer disposed on the first surface of the body and having a first opening formed therein; and
a second insulating layer disposed on the first insulating layer and having a second opening formed therein,
wherein at least a portion of the external electrode is disposed in the first opening and the second opening.

2. The coil component of claim 1, wherein a size of the first opening is different from a size of the second opening.

3. The coil component of claim 2, wherein a length of the first opening in the second direction is greater than a length of the second opening in the second direction.

4. The coil component of claim 2, wherein a length of the first opening in the third direction is greater than a length of the second opening in the third direction.

5. The coil component of claim 1, wherein the external electrode includes a first metal layer extending from the first surface of the body to the recesses and connected to both ends of the coil and a second metal layer disposed on the metal layer disposed on the first surface of the body.

6. The coil component of claim 5, wherein at least a portion of the first metal layer is disposed in the first opening, and at least a portion of the second metal layer is disposed in the second opening.

7. The coil component of claim 5, wherein at least a portion of the second insulating layer extends to an upper surface of the first metal layer.

8. The coil component of claim 5, wherein the first insulating layer is disposed on the second to sixth surfaces of the body and the recess to expose the first metal layer.

9. The coil component of claim 8, wherein the second insulating layer covers the first metal layer and the first insulating layer disposed on the second to sixth surfaces of the body.

10. The coil component of claim 1, further comprising:
a support member disposed within the body,
wherein the coil includes a coil pattern disposed on at least one surface of the support member and a first lead pattern and a second lead pattern extending to the third surface and the fourth surface of the body, respectively.

11. The coil component of claim 10, wherein the recesses include a first recess formed on the third surface of the body and a second recess formed on the fourth surface of the body, and the first lead pattern extends to the first recess and the second lead pattern extends to the second recess.

12. The coil component of claim 11, wherein the external electrode includes a first external electrode extending to the first recess and connected to the first lead pattern and a second external electrode extending to the second recess and connected to the second lead pattern, and the first and second external electrodes are spaced apart from each other in the first direction.

13. A coil component comprising:
a body including a first surface and a second surface opposing each other in a first direction, a third surface and a fourth surface opposing each other in a second direction, and a fifth surface and a sixth surface opposing each other in a third direction;
a coil disposed within the body and having both ends extending to the third surface and the fourth surface of the body;
an external electrode including a first metal layer disposed on the first surface of the body and a second metal layer disposed on the first metal layer and connected to both ends of the coil;
a first insulating layer disposed on the first surface of the body and surrounding the first metal layer; and
a second insulating layer disposed on the first insulating layer and surrounding the second metal layer,
wherein at least a portion of the second insulating layer is disposed on the first metal layer.

14. The coil component of claim 13, wherein the first metal layer extends from the first surface of the body to the third surface and the fourth surface of the body and is connected to both ends of the coil.

15. The coil component of claim 13, wherein the first insulating layer is disposed on the second to sixth surfaces of the body and exposes the first metal layer.

16. The coil component of claim 15, wherein the second insulating layer covers the first metal layer and the first insulating layer disposed on the second to sixth surfaces of the body.
